(19) United States
(12) Patent Application Publication
(10) Pub. No.: US 2024/0136132 A1
(43) Pub. Date: Apr. 25, 2024

(54) ELECTROMAGNETIC RELAY

(71) Applicant: OMRON Corporation, Kyoto-shi, Kyoto (JP)

(72) Inventors: Ayata HORIE, Kyoto-shi, Kyoto (JP); Hiroyuki IWASAKA, Kyoto-shi, Kyoto (JP); Ryota MINOWA, Kyoto-shi, Kyoto (JP); Shinichi OGAWA, Kyoto-shi, Kyoto (JP); Kohei OTSUKA, Kyoto-shi, Kyoto (JP)

(21) Appl. No.: 18/547,511

(22) PCT Filed: Jan. 18, 2022
(86) PCT No.: PCT/JP2022/001513

§ 371 Date: Aug. 22, 2023

(30) Foreign Application Priority Data
Mar. 5, 2021 (JP) 2021-035748

(51) Int. Cl. H01H 50/38; H01H 50/02; H01H 50/54

(52) U.S. Cl. CPC H01H 50/38; H01H 50/02; H01H 50/54

(57) ABSTRACT

An electromagnetic relay includes a case, a movable contact piece, a fixed terminal, a driving device, and an insulating wall. The movable contact piece includes a movable contact. The fixed terminal includes a fixed contact, a contact support portion, an extension portion, and a bent portion. The contact support portion supports the fixed contact. The extension portion extends from the contact support portion in a longitudinal direction of the movable contact piece. The bent portion extends in a bent shape from the extension portion in a first direction from the fixed contact toward the movable contact, and overlaps the movable contact piece in the longitudinal direction of the movable contact piece. The driving device is configured to move the movable contact piece. The insulating wall is integral with the case and is disposed between the bent portion and the movable contact piece.

### CROSS-REFERENCE TO RELATED APPLICATION

This application is the U.S. National Phase of International Application No. PCT/JP2022/001513, filed on Jan. 18, 2022. This application claims priority to Japanese Patent Application No. 2021-035748, filed Mar. 5, 2021. The contents of those two applications are incorporated by reference herein in their entireties.

### FIELD

The claimed invention relates to electromagnetic relays.

### BACKGROUND

An electromagnetic relay has a fixed terminal including a fixed contact and a movable contact piece including a movable contact configured to contact the fixed contact. In an energized state in which the movable contact is in contact with the fixed contact, a current flows between the movable contact and the fixed contact, which causes an electromagnetic repulsive force to act in the direction in which the movable contact separates from the fixed contact. Thus, with a large current flow, this electromagnetic repulsive force may decrease the contact pressure between the movable contact and the fixed contact.

The electromagnetic relay disclosed in Japanese Patent Application Publication No. 2012-243591 includes a portion on the fixed terminal: in the portion, a current flows in a direction opposite to the current flowing between the movable contact and the fixed contact in order to prevent the decrease in the contact pressure between the movable contact and the fixed contact due to electromagnetic repulsion. The fixed terminal has a C shape and is arranged so as to partially overlap the movable contact piece in the longitudinal direction of the movable contact piece.

In Japanese Patent Application Publication No. 2012-243591, an insulating cover is attached to the fixed terminal in order to protect the fixed terminal from arc that is generated between the contacts. However, such an insulating cover attached to the fixed terminal increases the assembly costs and parts costs of the electromagnetic relay.

### SUMMARY

An object of the claimed invention is to reduce the manufacturing cost of an electromagnetic relay equipped with a fixed terminal overlapping a movable contact piece in the longitudinal direction of the movable contact piece.

An electromagnetic relay according to one aspect of the claimed invention includes a case, a movable contact piece, a fixed terminal, a driving device, and an insulating wall. The case is comprised of insulating material. The movable contact piece includes a movable contact and is disposed inside the case. The first fixed terminal is held by the case. The first fixed terminal includes a fixed contact, a contact support portion, an extension portion, and a bent portion. The first fixed contact is disposed to face the movable contact. The contact support portion supports the fixed contact. The extension portion extends from the contact support portion in a longitudinal direction of the movable contact piece. The bent portion extends in a bent shape from the extension portion in a first direction from the fixed contact toward the movable contact and overlaps the movable contact piece in the longitudinal direction of the movable contact piece. The driving device is disposed inside the case and is configured to move the movable contact piece in the first direction and a second direction from the movable contact toward the fixed contact. The insulating wall is configured to insulate the bent portion from an arc generated between the fixed contact and the movable contact. The insulating wall is integral with the case and is disposed between the bent portion and the movable contact piece.

In the electromagnetic relay, when energized, a current flows in the bent portion of the fixed terminal in the direction opposite to the current flowing between the movable contact and the fixed contact. Thus, the bent portion of the fixed terminal is effective to decrease the electromagnetic repulsive force between the movable contact and the fixed contact during energization. In addition, the insulating wall, configured to insulate the bent portion of the fixed terminal from the arc generated between the fixed contact and the movable contact, is integral with the case that is comprised of insulating material, and the driving device is disposed inside the case. With the configuration, compared to a case where the insulating wall is a separate part from the case, the assembly costs and parts costs of the electromagnetic relay can be reduced. As a result, the manufacturing cost of the electromagnetic relay can be reduced.

The fixed terminal may be held only by the case. In this case, the assembly costs and parts costs of the electromagnetic relay can be further reduced.

The contact support portion of the fixed terminal may be apart from the case. In this case, the contact support portion is less likely to disturb the movement of the arc.

The case may include a case body having an opening that is open on one side in the lateral direction of the movable contact piece, a lid configured to close the opening, and a groove formed in the case body and in which the fixed terminal is inserted from one side in the lateral direction of the movable contact piece. In this case, the fixed terminal can be held in the case with a simple configuration.

The fixed terminal may further include an external connecting portion disposed outside the case. The case may include an inner support portion configured to support a surface of the extension portion of the fixed terminal facing the first direction inside the case, and an outer support portion configured to support a surface of the external connecting portion facing the first direction. In this case, when the movable contact comes into contact with the fixed contact and the fixed terminal is pressed by the movable contact piece, the contact support portion becomes less likely to move in the second direction.

The electromagnetic relay may further include one or more magnets configured to generate a magnetic field to stretch the arc, and a yoke connected to the one or more magnets. At least one of the one or more magnets and the yoke may be disposed adjacent to the inner support portion. In this case, the inner support portion can be reinforced by at least one of the one or more magnets and the yoke.

The electromagnetic relay may further include one or more magnets configured to generate a magnetic field to stretch the arc, and a yoke connected to the one or more magnets. At least one of the one or more magnet and the yoke may be disposed adjacent to the outer support portion. In this case, the outer support portion can be reinforced by at least one of the one or more magnets and the yoke.

### BRIEF DESCRIPTION OF THE DRAWINGS

FIG. 1 is a perspective view of an electromagnetic relay in accordance with the claimed invention.

FIG. 2 is a partial perspective view of an electromagnetic relay in accordance with the claimed invention, with the lid removed.

FIG. 3 is a cross-sectional view of an electromagnetic relay in accordance with the claimed invention.

FIG. 4 is a partial cross-sectional view of an electromagnetic relay in accordance with the claimed invention.

### DETAILED DESCRIPTION

An embodiment of an electromagnetic relay 100 according to one aspect of the claimed invention will be described below with reference to the drawings. When referring to the drawings in the description below, the X1 direction is the leftward direction, the X2 direction is the rightward direction, the Y1 direction is the forward direction, the Y2 direction is the rearward direction, the Z1 direction is the upward direction, and the Z2 direction is the downward direction. These directions are defined for convenience of explanation, and do not limit the directions in which the electromagnetic relay 100 is arranged. In the present embodiment, the Z2 direction is an example of a first direction, and the Z1 direction is an example of a second direction.

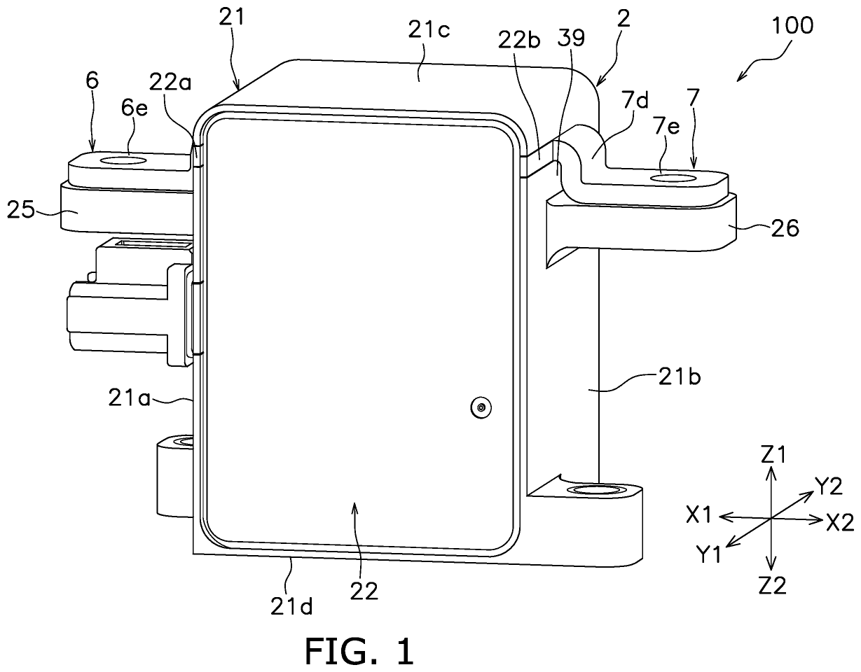

As shown in FIGS. 1 to 3, the electromagnetic relay 100 includes a case 2, a contact device 3, and a driving device 4.

The case 2 is a generally rectangular box in shape and is comprised of insulating material such as resin. The case 2 includes a case body 21, a lid 22, inner support portions 23, 24, outer support portions 25, 26, and grooves 27, 28.

The case body 21 includes a left wall 21a, a right wall 21b, an upper wall 21c, a lower wall 21d, a rear wall (not shown), and an opening 21e. The left wall 21a and the right wall 21b extend in the front-rear direction and the up-down direction. The left wall 21a faces the right wall 21b in the left-right direction. The upper wall 21c and the lower wall 21d extend in the front-rear direction and the left-right direction. The upper wall 21c faces the lower wall 21d in the up-down direction. The rear wall extends in the left-right direction and the up-down direction. The rear wall is connected to the left wall 21a, the right wall 21b, the upper wall 21c and the lower wall 21d. The opening 21e is rectangular and is open forward from the rear wall. The lid 22 is attached to the case body 21 so as to close the opening 21e.

The lid 22 is attached to the case body 21 from the front toward the opening 21e so as to close the opening 21e. The lid 22 includes support protrusions 22a, 22b protruding forward, as shown in FIG. 1. The support protrusion 22a is inserted into the groove 27. The support protrusion 22b is inserted into the groove 28.

The inner support portion 23 protrudes rightward from an inner surface of the left wall 21a. The inner support portion 24 protrudes leftward from an inner surface of the right wall 21b. The inner support portions 23, 24 each have an upper flat surface. That is, the upper surfaces of the inner support portions 23, 24 include a plane perpendicular to the up-down direction.

The outer support portion 25 protrudes leftward from an outer surface of the left wall 21a. The outer support portion 25 is positioned below the inner support portion 23. The outer support portion 26 protrudes rightward from an outer surface of the right wall 21b. The outer support portion 26 is positioned below the inner support portion 24. The outer support portions 25 and 26 each have an upper flat surface. That is, the upper surfaces of the outer support portions 25 and 26 include a plane perpendicular to the up-down direction.

The groove 27 is formed in the upper portion of the left wall 21a. The groove 27 extends in the front-rear direction and is open at the front. The groove 28 is formed in the upper portion of the right wall 21b. The groove 28 extends in the front-rear direction and is open at the front.

The contact device 3 includes a first fixed terminal 6, a second fixed terminal 7, and a movable contact piece 8.

The first fixed terminal 6 and the second fixed terminal 7 may be plate terminals and are comprised of conductive material. The first fixed terminal 6 and the second fixed terminal 7 extend in the left-right direction in a bent shape. The first fixed terminal 6 and a second fixed terminal 7 extend across the interior and exterior of the case 2. The first fixed terminal 6 and the second fixed terminal 7 are spaced apart from each other in the left-right direction. The first fixed terminal 6 and the second fixed terminal 7 are held by the case 2. In this embodiment, the first fixed terminal 6 and the second fixed terminal 7 are held only by the case 2. The first fixed terminal 6 and the second fixed terminal 7 are inserted into the case body 21 from the lateral direction (the front-rear direction here) of the movable contact piece 8 to be held by the case 2. The first fixed terminal 6 and the second fixed terminal 7 partially overlaps the movable contact piece 8 in the left-right direction.

The first fixed terminal 6 is inserted into the case body 21 through the groove 27. The first fixed terminal 6 is held between the groove 27 and the support protrusion 22a to be limited in movement in the front-rear direction.

The first fixed terminal 6 includes a first fixed contact 6a, a contact support portion 6b, an extension portion 6c, a bent portion 6d, and an external connecting portion 6e. The first fixed contact 6a is positioned inside the case 2. The first fixed contact 6a is arranged to face the movable contact piece 8 in the up-down direction. The first fixed contact 6a is positioned on the lower surface of the contact support portion 6b.

The contact support portion 6b supports the first fixed contact 6a. The contact support portion 6b is located at the right end of the first fixed terminal 6. The contact support portion 6b is separated from the case 2 in the left-right direction. The front and rear sides of the contact support portion 6b are covered with the rear wall and the lid 22. The contact support portion 6b is separated from the upper wall 21c of the case 2 in the up-down direction. That is, the contact support portion 6b is separated from the case 2 and is not held by the case 2.

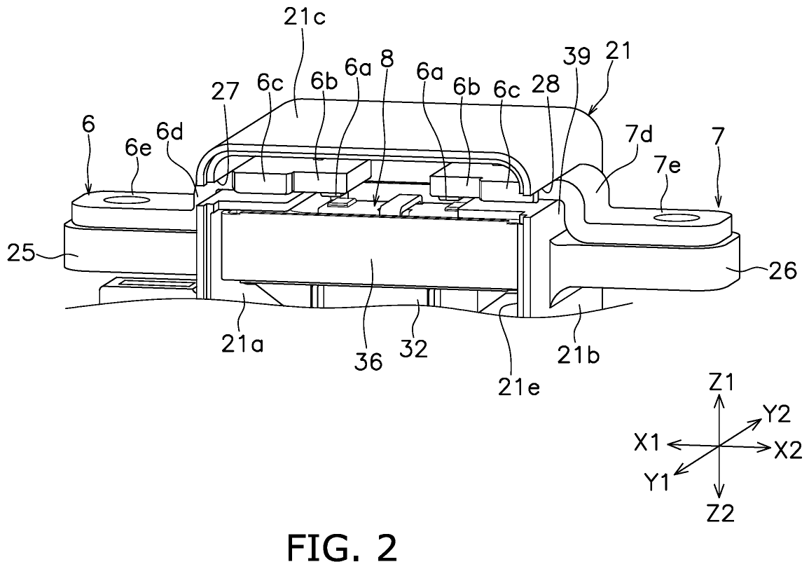

The extension portion 6c is connected to the contact support portion 6b. The extension portion 6c extends in the left-right direction from the contact support portion 6b. Specifically, the extension portion 6c extends leftward from the left end of the contact support portion 6b. As shown in FIG. 2, the extension portion 6c partially extends in the front-rear direction beyond the contact support portion 6b. The left end of the extension portion 6c penetrates the left wall 21a in the left-right direction. The extension portion 6c is supported on the upper surface of the inner support 23. The front and rear sides of the extension portion 6c are covered by the rear wall and the lid 22. The upper surface of the extension portion 6c is supported by the groove 27 and the protrusion protruding downward from the upper wall 21c. The extension portion 6c is held, at the portion extending beyond the contact support portion 6b in the front-rear direction, by the case body 21 and the lid 22 so as to be limited in movement in the left-right direction. The thickness direction of the extension portion 6c matches the up-down direction, and the lateral direction of the extension portion 6c matches the front-rear direction.

The bent portion 6d is positioned outside the case 2. The bent portion 6d is connected to the extension portion 6c. The bent portion 6d extends in a bending form in the Z2 direction from the left end of the extension portion 6c. The bent portion 6d extends in the up-down direction. The bent portion 6d is located at a position close to the left wall 21a of the case body 21 so as to face the left wall 21a. The bent portion 6d overlaps the movable contact piece 8 in the left-right direction. The thickness direction of the bent portion 6d matches the left-right direction, and the lateral direction of the bent portion 6d matches the front-rear direction.

The external connecting portion 6e is positioned outside the case 2 and connected to the bent portion 6d. The external connecting portion 6e extends from the bent portion 6d in the left-right direction. Specifically, the external connecting portion 6e extends in a bent form leftward from the lower end of the bent portion 6d. The external connecting portion 6e is supported on the upper surface of the outer support portion 25. The external connecting portion 6e is configured to be connected to an external terminal (not shown) such as a busbar.

The second fixed terminal 7 is bilaterally symmetric to the first fixed terminal 6, and it will be explained briefly. The second fixed terminal 7 includes a second fixed contact 7a, a contact support portion 7b, an extension portion 7c, a bent portion 7d, and an external connecting portion 7e. The second fixed contact 7a is disposed to face the movable contact piece 8 in the up-down direction at a position away from the first fixed contact 6a in the left-right direction. The contact support portion 7b supports the second fixed contact 7a. The extension portion 7c extends rightward from the right end of the contact support portion 7b and is supported on the upper surface of the inner support portion 24. The bent portion 7d extends in the up-down direction. The bent portion 7d overlaps the movable contact piece 8 in the left-right direction. The bent portion 7d is located outside the case 2 so as to face the right wall 21b of the case body 21. The external connecting portion 7e extends in the left-right direction and is supported on the upper surface of the outer support portion 26.

The movable contact piece 8 is a plate terminal elongated in one direction and is comprised of conductive material. The movable contact piece 8 is arranged inside the case 2. The movable contact piece 8 extends in the left-right direction inside the case 2. The longitudinal direction of the movable contact piece 8 matches the left-right direction. The lateral direction of the movable contact piece 8 matches the front-rear direction.

The movable contact piece 8 includes a first movable contact 8a and a second movable contact 8b. The first movable contact 8a is disposed to face the first fixed contact 6a. The second movable contact 8b is disposed to face the second fixed contact 7a.

The movable contact piece 8 is movable in the up-down direction. Specifically, the movable contact piece 8 is movable in the Z1 and Z2 directions. The Z1 direction is the direction in which the first movable contact 8a approaches the first fixed contact 6a. In other words, the Z1 direction is the direction from the first movable contact 8a toward the first fixed contact 6a. The Z2 direction is the direction in which the first movable contact 8a moves away from the first fixed contact 6a. In other words, the Z2 direction is the direction from the first fixed contact 6a toward the first movable contact 8a.

The driving device 4 is arranged inside the case 2. The driving device 4 is configured to move the movable contact piece 8 in the Z1 direction and the Z2 direction. The driving device 4 includes a movable mechanism 11, a coil 12, a movable iron core 13, a fixed iron core 14, a yoke 15, and a return spring 16.

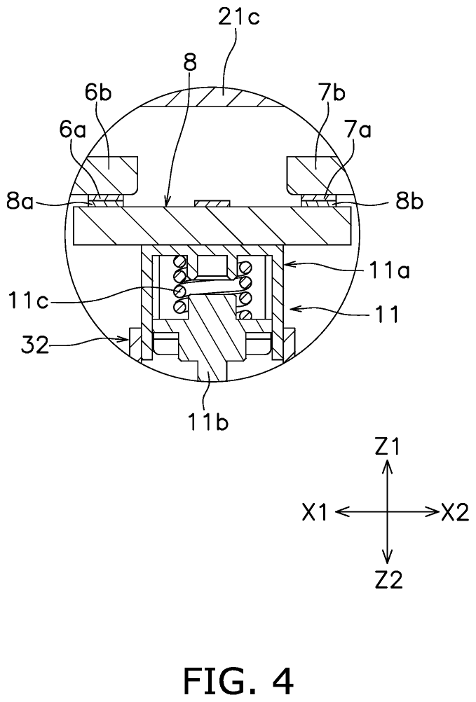

The movable mechanism 11 is connected to the movable contact piece 8. As shown in FIG. 4, the movable mechanism 11 includes a holder 11a, a drive shaft 11b, and a contact spring 11c. The holder 11a holds the movable contact piece 8. The holder 11a moves integrally with the movable contact piece 8. The drive shaft 11b extends in the up-down direction. The drive shaft 11b is disposed below the movable contact piece 8. The drive shaft 11b is connected to the holder 11a so as to be relatively movable in the up-down direction with respect to the holder 11a. The contact spring 11c is arranged between the holder 11a and the drive shaft 11b. The contact spring 11c urges the movable contact piece 8 in the Z1 direction via the holder 11a.

When a voltage is applied to excite the coil 12, the coil 12 generates an electromagnetic force causes the movable iron core 13 to move in the Z1 direction. The movable iron core 13 is fixed to the drive shaft 11b so as to be movable integrally therewith. The fixed iron core 14 is disposed above the movable iron core 13 so as to face the movable iron core 13. The yoke 15 is arranged to surround the coil 12. The yoke 15 is connected to the fixed iron core 14. The return spring 16 urges the movable iron core 13 in the Z2 direction.

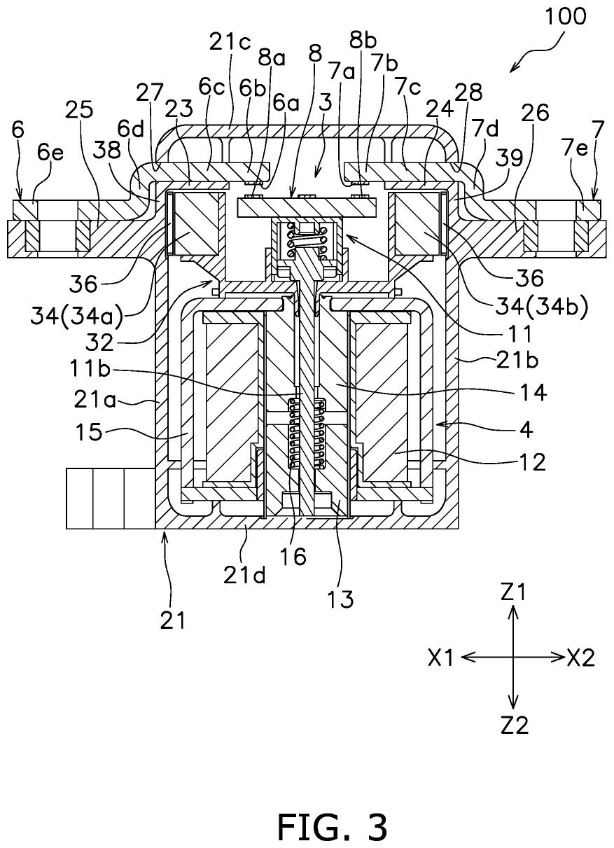

The operation of the electromagnetic relay 100 is generally the same as before, and it will be briefly described. FIG. 3 shows a state in which the coil 12 is not energized. In this state, the first movable contact 8a is separated from the first fixed contact 6a, and the second movable contact 8b is separated from the second fixed contact 7a. When the coil 12 is excited, the movable iron core 13 moves in the Z1 direction together with the drive shaft 11b against the biasing force of the return spring 16. The movement of the drive shaft 11b in the Z1 direction pushes the movable contact piece 8 in the Z1 direction via the contact spring 11c, and thereby the movable contact piece 8 moves in the Z1 direction. As a result, as shown in FIG. 4, the first movable contact 8a comes in contact with the first fixed contact 6a, and the second movable contact 8b comes in contact with the second fixed contact 7a. When the voltage application to the coil 12 is stopped, the biasing force of the return spring 16 moves the drive shaft 11b together with the movable iron core 13 in the Z1 direction. As a result, the movable contact piece 8 moves in the Z2 direction, the first movable contact 8a separates from the first fixed contact 6a, and the second movable contact 8b separates from the second fixed contact 7a.

The electromagnetic relay 100 further includes an inner member 32, one or more magnets 34, a yoke 36, and insulating walls 38,39. The inner member 32 guides movement of the movable mechanism 11. The inner member 32 is disposed above the coil 12. The inner member 32 is a generally rectangular box in shape that is open in the Z1 direction, and is partially or entirely comprised of insulating material such as resin. The inner member 32 is entirely arranged below the contact support portions 6b, 7b and the extension portions 6c, 7c.

The one or more magnets 34 are a permanent magnet of a rectangular parallelepiped shape, and include a first magnet 34a and a second magnet 34b. The first magnet 34a and the second magnet 34b are supported by the inner member 32. The first magnet 34a and the second magnet 34b are arranged around the inner member 32 and are disposed to face each other in the left-right direction. The first magnet 34a is disposed between the inner member 32 and the insulating wall 38. The first magnet 34a is disposed adjacent to the inner support portion 23 and the outer support portion 25. The first magnet 34a is disposed below the inner support portion 23. The first magnet 34a is disposed rightward of the outer support portion 25. The second magnet 34b is disposed between the inner member 32 and the insulating wall 39. The second magnet 34b is disposed adjacent to the inner support portion 24 and the outer support portion 26. The second magnet 34b is disposed below the inner support portion 24. The second magnet 34b is disposed leftward of the outer support portion 26.

The yoke 36 is arranged outside the first magnet 34a and the second magnet 34b so as to surround the first magnet 34a and the second magnet 34b in the left-right direction and the front-rear direction. The yoke 36 is partially arranged between the first magnet 34a and the insulating wall 38 and between the second magnet 34b and the insulating wall 39. The yoke 36 is supported by an inner surface of the case 2 and an outer peripheral surface of inner member 32. The yoke 36 is positioned adjacent to the inner support portions 23, 24 and the outer support portions 25, 26.

The insulating wall 38 is integral with the case 2. The insulating wall 38 is positioned between the bent portion 6d of the first fixed terminal 6 and the movable contact piece 8. The insulating wall 38 is configured to insulate the bent portion 6d from the arc that is generated between the first fixed contact 6a and the first movable contact 8a. The insulating wall 38 extends in the front-rear and the left-right directions. The insulating wall 38 is disposed below the extension portion 6c. The insulating wall 38 covers the right side of the bent portion 6d. The insulating wall 38 is constituted by part of the left wall 21a of the case 2. The insulating wall 38 overlaps the bent portion 6d and the movable contact piece 8 in the left-right direction. The insulating wall 38 overlaps the first magnet 34a and the yoke 36 in the left-right direction.

The insulating wall 39 is integral with the case 2. The insulating wall 39 is positioned between the bent portion 7d of the second fixed terminal 7 and the movable contact piece 8. The insulating wall 39 is configured to insulate the bent portion 7d from the arc that is generated between the second fixed contact 7a and the second movable contact 8b. The insulating wall 39 extends in the front-rear direction and left-right direction. The insulating wall 38 is disposed below the extension portion 7c. The insulating wall 39 covers the left side of the bent portion 7d. The insulating wall 39 is constituted by part of the right wall 21b of the case 2. The insulating wall 39 overlaps the bent portion 7d and the movable contact piece 8 in the left-right direction. The insulating wall 39 overlaps the second magnet 34b and the yoke 36 in the left-right direction.

In the electromagnetic relay 100 configured as described above, when energized, a current flows through the bent portion 6d of the first fixed terminal 6 in the direction opposite to the current flowing between the first movable contact 8a and the first fixed contact 6a. As a result, the bent portion 6d of the first fixed terminal 6 is effective to decrease the electromagnetic repulsion between the first movable contact 8a and the first fixed contact 6a during energization. Also, the insulating wall 38 for insulating the bent portion 6d of the first fixed terminal 6 from an arc that is generated between the first fixed contact 6a and the first movable contact 8a is integral with the case 2 that is comprised of insulating material, and the driving device 4 is arranged inside the case 2. As such, compared to a case where the insulating wall 38 is formed as a separate part from the case 2, the assembly cost and part cost of the electromagnetic relay 100 can be reduced. As a result, the manufacturing cost of the electromagnetic relay 100 can be reduced. A similar effect can be obtained with the insulating wall 39 as well.

An embodiment of the electromagnetic relay according to one aspect of the claimed invention has been described above, but the claimed invention is not limited to the above embodiment, and various modifications can be made without departing from the scope of the invention.

In the above embodiment, the bent portion 6d of the first fixed terminal 6 is arranged outside the case 2, but a configuration is possible in which the thickness of the left wall 21a is increased so that the bent portion 6d is fitted inside the left wall 21a of the case body 21. Alternatively, the bent portion 6d may be arranged inside the case 2. In the case where the bent portion 6d is arranged inside the case 2, the insulating wall 38 is formed in the case body 21 separately from the left wall 21a of the case 2, rather than being part of the left wall 21a.

In the above embodiment, the first fixed terminal 6 is held only by the case 2, but the first fixed terminal 6 may be held by the case 2 and other members.

In the above embodiment, the driving device 4 pushes the movable iron core 13 upward, but a configuration is possible in which the driving device 4 pushes the movable iron core 13 downward. In this case, the movable contact piece 8 is disposed above the first fixed terminal 6 and the second fixed terminal 7.

### REFERENCE NUMERALS

2 Case
4 Driving device
6 First fixed terminal (Example of fixed terminal)
6a First fixed contact (Example of fixed contact)
6b Contact support portion
6c Extension portion
6d Bent portion
6e External connecting portion
8 Movable contact piece
8a First movable contact (Example of movable contact)
21 Case body
21e Opening
22 Lid
34 One or more magnet
36 Yoke
38 Insulating wall
100 Electromagnetic relay

1. An electromagnetic relay, comprising:
a case comprised of insulating material;
a movable contact piece including a movable contact, the movable contact piece being disposed inside the case;
a fixed terminal held by the case, the fixed terminal including a fixed contact disposed to face the movable contact, a contact support portion configured to support the fixed contact, an extension portion extending from the contact support portion in a longitudinal direction of the movable contact piece, and a bent portion extending in a bent shape from the extension portion in a first direction from the fixed contact toward the movable contact, the bent portion overlapping the movable contact piece in the longitudinal direction of the movable contact piece;
a driving device disposed inside the case, the driving device being configured to move the movable contact piece in the first direction and a second direction from the movable contact toward the fixed contact; and
an insulating wall that is integral with the case, the insulating wall being disposed between the bent portion and the movable contact piece, the insulating wall configured to insulate the bent portion from an arc generated between the fixed contact and the movable contact.

2. The electromagnetic relay according to claim 1, wherein the fixed terminal is held only by the case.

3. The electromagnetic relay according to claim 1, wherein the contact support portion of the fixed terminal is apart from the case.

4. The electromagnetic relay according to claim 1, wherein the case includes
a case body having an opening that is open on one side in a lateral direction of the movable contact piece;
a lid configured to close the opening; and
a groove formed in the case body and in which the fixed terminal is inserted from one side in the lateral direction of the movable contact piece.

5. The electromagnetic relay according to claim 1, wherein
the fixed terminal further includes an external connecting portion disposed outside the case, and
the case includes an inner support portion configured to support a first surface of the extending portion of the fixed terminal and an outer support portion configured to support a second surface of the external connecting portion, the first surface facing the first direction inside the case, the second surface facing the first direction.

6. The electromagnetic relay according to claim 5, further comprising:
one or more magnets configured to generate a magnetic field to stretch the arc; and
a yoke connected to the one or more magnets, wherein
at least one of the one or more magnets and the yoke is disposed adjacent to the inner support portion.

7. The electromagnetic relay according to claim 5, further comprising:
one or more magnets configured to generate a magnetic field to stretch the arc; and
a yoke connected to the one or more magnets, wherein
at least one of the one or more magnets and the yoke is disposed adjacent to the outer support portion.
